(19) United States
(12) Patent Application Publication
(10) Pub. No.: US 2010/0245442 A1
(43) Pub. Date: Sep. 30, 2010

(54) METHOD FOR DETECTING DEFECTIVE LIQUID EJECTION, AND DEFECTIVE LIQUID EJECTION DETECTION DEVICE

(75) Inventors: Tsuneo Kasai, Azumino-shi (JP); Hidekuni Moriya, Chino-shi (JP); Kenji Fukasawa, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/732,102

(22) Filed: Mar. 25, 2010

(30) Foreign Application Priority Data
Mar. 26, 2009 (JP) 2009-077326

(51) Int. Cl. B41J 29/393

(52) U.S. Cl. 347/14; 347/19

(57) ABSTRACT

A method for detecting a defective liquid ejection that includes a) reading, by means of a sensor, an image which is formed on a medium by nozzles ejecting a fluid onto the medium in accordance with image data while being moved relative to the medium in a relative movement direction, b) obtaining differences between pixel values of read data pixels continuously arranged in a row in a direction intersecting with the relative movement direction in data read by the sensor and pixel values of image data pixels corresponding to the read data pixels, and c) detecting a defective liquid ejection of the nozzle by comparing a maximum difference value at a point where the differences show a maximum value with a non-maximum difference value at a time when the differences do not show a maximum value.

### BACKGROUND

1. Technical Field

The present invention relates to a method for detecting a defective liquid ejection and an ejection failure detection device.

2. Related Art

There is a technology in which an image which has been formed on a medium by a nozzle ejecting a fluid onto the medium in accordance with image data while being moved relative to the medium in a relative movement direction is read by means of a sensor, reference data having a resolution the same as a reading resolution is produced on the basis of the image data, and the data read by means of the sensor and the reference data are compared with each other so that a defective liquid ejection of the nozzle is detected. For example, JP-A-2008-64486 discloses a technology of the related art in which a reference image and an inspection image on a printed material are compared with each other so as to detect a defect.

However, a problem arises that false detection due to a reading error of a sensor may occur in the existing technology.

### SUMMARY

An advantage of some aspects of the invention is that it prevents false detection due to a reading error of a sensor.

A method for detecting a defective liquid ejection according to a first aspect of the invention includes a) reading, by means of a sensor, an image which is formed on a medium by nozzles ejecting a fluid to the medium in accordance with image data while being moved relative to the medium in a relative movement direction, b) obtaining differences between pixel values of read data pixels continuously arranged in a row in a direction intersecting with the relative movement direction in data read by the sensor and pixel values of image data pixels corresponding to the read data pixels, and c) detecting a defective liquid ejection of a nozzle by comparing a maximum difference value at a time when the differences show a maximum value with a non-maximum difference value at a time when the differences do not show a maximum value.

Other features of the invention will become clear by the specification and the drawings which will be described in detail below.

### BRIEF DESCRIPTION OF THE DRAWINGS

The invention will be described with reference to the accompanying drawings, wherein like numbers reference like elements.

FIG. 1 is a block diagram showing a structure of a printing system used in an embodiment according to the invention.

FIG. 2 is a cross sectional view showing an entire structure of a printer.

FIG. 3 is an explanatory view showing arrangement of a plurality of heads at a lower face of a head unit.

FIG. 4 is a schematic view showing arrangement of nozzles on a head.

FIG. 5 is a schematic explanatory view showing arrangement of the nozzles and a way of forming dots.

FIG. 6A is a schematic view showing a printed image at a time when a defective liquid ejection occurs.

FIG. 6B is an enlarged view showing a portion having a defective dot enclosed by a square in the FIG. 6A.

FIG. 7 is an explanatory view showing read data read by a scanner when its scan rate is 7 ms.

FIG. 8A is a schematic view showing an image obtained by reading the printed image in FIG. 6A by using the scanner.

FIG. 8B is an enlarged view showing a portion having a defective dot enclosed by a square in FIG. 8A.

FIG. 9 is a flowchart showing a process of detecting a defective liquid ejection.

FIG. 10 is a part of a line chart connecting points obtained by plotting a difference between each pixel value of read data pixels in one row on a reading line and each pixel value of reference data pixels corresponding to the pixels in the one row.

FIG. 11 is a part of a line chart connecting points obtained by plotting a difference between each pixel value of read data pixels in one row on a read line and a each pixel value of reference data pixels corresponding to the pixels in the one row.

FIG. 12A is a schematic view showing an entire structure of a serial type printer.

FIG. 12B is a cross sectional view showing an entire structure of a printer.

FIG. 13 is an explanatory view showing read data read by a scanner when its scan rate is 7 ms.

### DESCRIPTION OF EXEMPLARY EMBODIMENTS

### Overview of Disclosure

At least the following things will be apparent from the descriptions of the specification and the appended drawings in the specification.

Namely, disclosed is a method for detecting a defective liquid ejection according to the first aspect of the invention. The method includes reading, by means of a sensor, an image formed on a medium by a nozzle ejecting a fluid on the medium in accordance with image data while being moved relative to the medium in a relative movement direction, obtaining differences between pixel values of read data pixels in a row continuously arranged in a direction intersecting with the relative movement direction in the data read by the sensor and pixel values of image data pixels corresponding to the read data pixels, and detecting a defective liquid ejection of a nozzle by comparing a maximum difference value at a time when the differences show a maximum value with a non-maximum difference value at a time when the differences do not show a maximum value.

In accordance with the above method for detecting a defective liquid ejection, it is possible to prevent false detection in the detection of a defective liquid ejection. That is, while the pixel value of the image read by the sensor is affected by a light sensitivity of the sensor or a luminance of an illumination, the differences between the read data pixels and the image data pixels are obtained and the differences are compared with each other so that false detection influenced thereby can be prevented.

In addition, in the method for detecting a defective liquid ejection according to the first aspect of the invention, the non-maximum difference value is preferably a minimum difference value at a point where the difference shows its minimum value and is preferably the closest to a point where the difference shows a maximum value in points where the differences show a minimum value. With this method for detecting a defective liquid ejection, the detection of a defective liquid ejection is performed on the basis of the difference between the maximum value and the minimum value so that it is possible to prevent false detection in the detecting of a defective liquid ejection.

Further, in addition, the method for detecting a defective liquid ejection according to the first aspect of the invention preferably further includes forming reference data having a resolution the same as the reading resolution in the relative movement direction on the basis of the image data. When an image formed on the medium is to be read by means of the sensor, the reading is performed in such a manner that a reading resolution by the sensor is made to be lower than the resolution of the image data in the relative movement direction. When the difference is obtained, differences between pixel values of the read data pixels and pixel values of reference data pixels respectively corresponding to the read data pixels in the reference data are obtained from one end to the other end of the row. With the above method for detecting a defective liquid ejection, it is possible to reduce an amount of processing data in the detection of a defective liquid ejection while maintaining accuracy in the detection of a defective liquid ejection.

Further, in addition, in the method for detecting a defective liquid ejection according to the first aspect of the invention, the reading is preferably performed by means of the sensor in such a manner that a reading resolution by the sensor is made to be higher than a resolution of the image data in a direction intersecting with the relative movement direction. With the above method for detecting a defective liquid ejection, it is possible to specify which nozzle has a defective liquid ejection when the defective liquid ejection occurs.

Further, in addition, in the method for detecting a defective liquid ejection according to the first aspect of the invention, the reference data is preferably produced by processing the image data. With the above method for detecting a defective liquid ejection, it is possible to produce the reference data having accuracy sufficient for detecting a defective liquid ejection so that a defective liquid ejection can be adequately detected.

Furthermore, disclosed is an ejection failure detection device according to a second aspect of the invention. The ejection failure detection device includes a sensor that reads an image which is formed on a medium by a nozzle ejecting a liquid onto the medium while being moved relative to the medium in a relative movement direction, a difference computing section that computes differences between pixel values of read data pixels continuously arranged in a row in a direction intersecting with the relative movement direction in the data read by the sensor and pixel values of image data pixels corresponding to the read data pixels, and a detecting section that compares a maximum difference value at a time when the differences show a maximum value with a non-maximum difference value at a time when the differences do not show a maximum value so as to detect a defective liquid ejection of a nozzle.

In accordance with the above ejection failure detection device, it is possible to prevent false detection in the detection of a defective liquid ejection.

### First Embodiment

[Entire Structure]

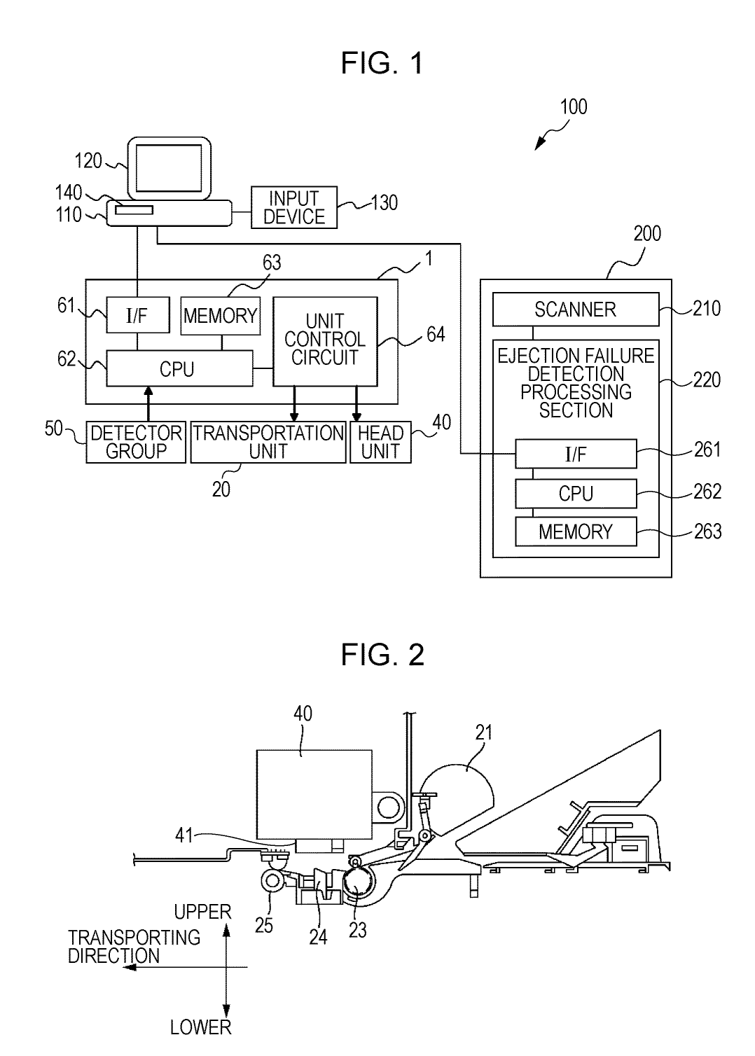

FIG. 1 is a block diagram showing a structure of a printing system 100 used in a first embodiment. As shown in FIG. 1, the printing system 100 includes a printer 1, a computer 110, a display device 120, an input device 130, a recording/playing device 140, and a detection device 200 as an example of an ejection failure detection device. The printer 1 is capable of printing an image on a medium such as a paper sheet, a cloth or a film. The computer 110 is communicably connected to the printer 1 and outputs image data to the printer 1 so as to cause the printer 1 to print an image in accordance with the image data.

A printer driver is installed in the computer 110. The printer driver is a program that causes the display device 120 to display a user interface and converts image data received from an application program into image data for printing. The printer driver is recorded on a recording medium (a computer-readable recording medium) such as a flexible disk (FD) or a CD-ROM. Alternatively, the printer driver can be downloaded onto the computer 110 via the Internet. Meanwhile, the program is constituted by code for realizing various functions.

[Structure of Printer 1]

FIG. 2 is a cross-sectional view showing the entire structure of the printer 1. The printer 1 is equipped with a transportation unit 20, a head unit 40, a detector group 50 and a controller 60. The printer 1 that receives image data from the computer 110 as an external device causes the controller 60 to control each of the units (the transportation unit 20, the head unit 40). The controller 60 controls the units in accordance with the image data received from the computer 110 so as to perform printing on a paper sheet. States in the printer 1 are monitored by means of the detector group 50 and the detector group 50 outputs detection results to the controller 60. The controller 60 controls the units on the basis of the detection results received from the detector group 50.

The transportation unit 20 is adapted to transport a medium (e.g., a paper sheet S) in a transporting direction. The transportation unit 20 is equipped with a paper feed roller 21, a transportation motor (not shown), a transportation roller 23, a platen 24, and a paper discharge roller 25. The paper feed roller 21 serves as a roller for feeding a paper sheet inserted into a paper insertion slot into the inside of the printer 1. The transportation roller 23 serves as a roller for transporting a paper sheet S fed by the paper feed roller 21 to a region at which printing can be performed (hereinafter, referred to as the printing region) and is driven by the transportation motor. The platen 24 supports the paper sheet S being printed. The paper discharge roller 25 serves as a roller for discharging the paper sheet S to the outside of the printer 1 and is provided at downstream of the printing region in the transporting direction. The paper discharge roller 25 rotates in synchronization with the transportation roller 23.

Meanwhile, the paper sheet S is pinched between the transportation roller 23 and a follower roller while the transportation roller 23 transports the paper sheet S. With this configuration, the posture of the paper sheet S is stabilized. On the other hand, the paper sheet S is pinched between the paper discharge roller 25 and a follower roller while the paper discharge roller 25 transports the paper sheet S.

The head unit 40 is adapted to eject ink onto the paper sheet S. The head unit 40 forms dots on the paper sheet S by ejecting ink onto the paper sheet S being transported so as to print an image on the paper sheet S. The printer 1 is of a line printer type so that the head unit 40 can simultaneously form dots over the whole paper width.

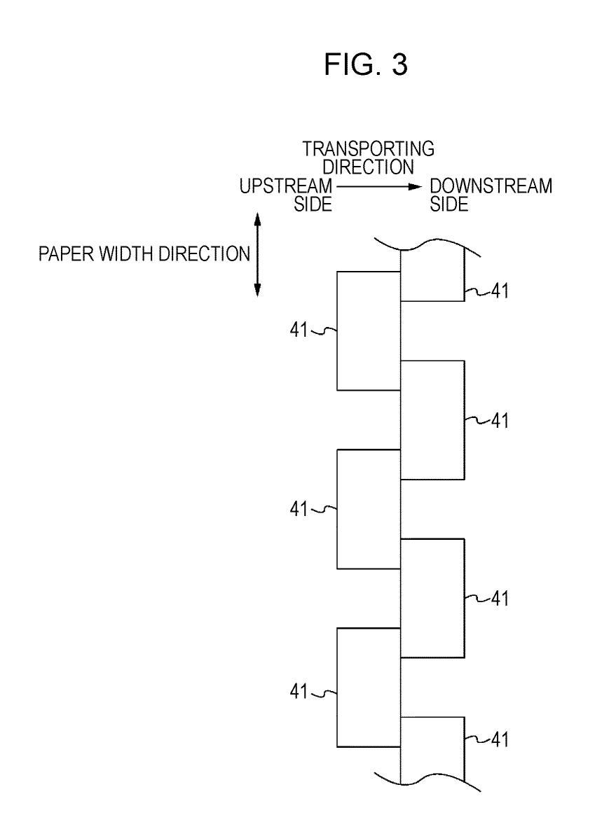

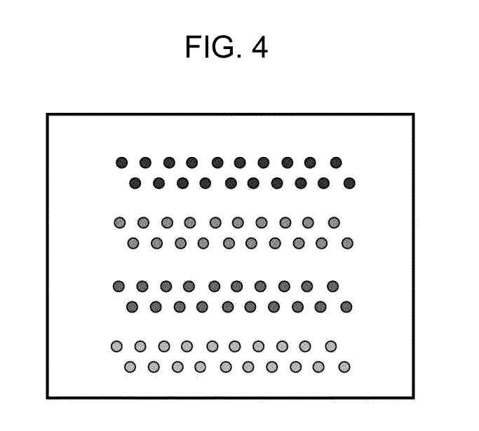

FIG. 3 is an explanatory view showing an arrangement of a plurality of heads on a lower face of the head unit 40. As shown in FIG. 3, the plurality of heads 41 are arranged in a staggered fashion along the paper width direction. FIG. 4 is a schematic view showing arrangement of nozzles on the head 41. As shown in FIG. 4, a black ink nozzle row, a cyan ink nozzle row, a magenta ink nozzle row and a yellow ink nozzle row are formed on each of the heads 41. Each of the nozzle rows has a plurality of nozzles for ejecting ink. The plurality of nozzles of each nozzle row are arranged along the paper width direction at a predetermined pitch. Namely, the nozzle rows of each of the heads 41 form nozzle groups having a width the same as that of the paper sheet S.

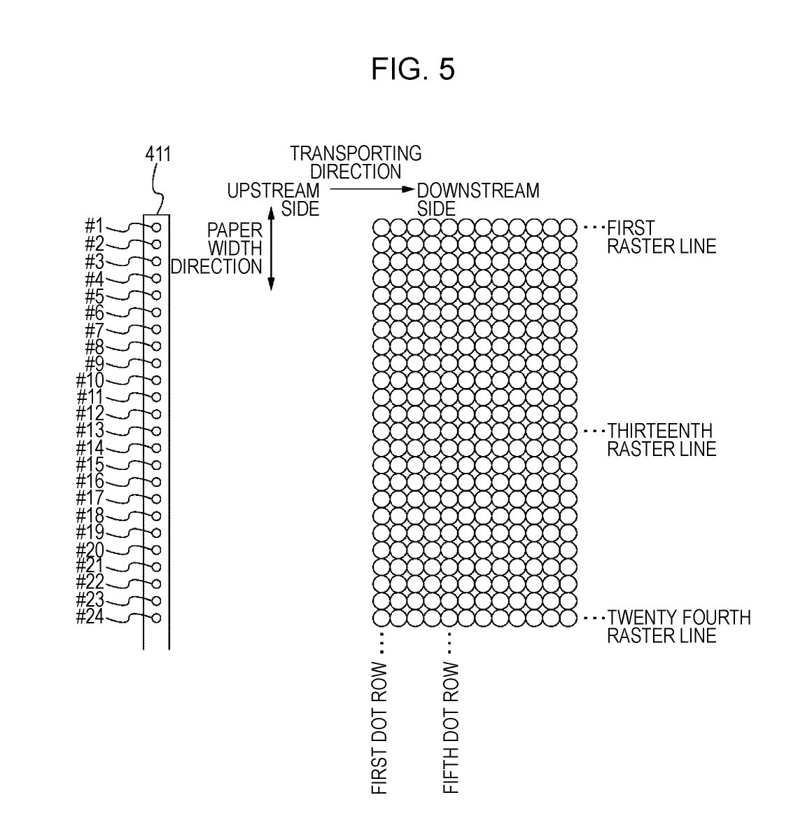

FIG. 5 is an explanatory view briefly showing arrangement of the nozzles and a way of forming dots. Here, in the head unit 40, a nozzle group having a predetermined nozzle pitch is constituted by the nozzle rows of the heads. As shown in FIGS. 3 and 4, actual positions of the nozzles in the transporting direction are different from each other. However, by making the ejection timings different from one another, the nozzle group constituted by the respective nozzle rows corresponding to the heads can serve as nozzles arranged in a line as shown in FIG. 5. In addition, for ease of explanation, it is assumed that only a nozzle group of black ink is provided.

The nozzle group is constituted by nozzles arranged in the paper width direction at a pitch of 1/720 inch. The nozzles are sequentially numbered from the upper portion in an ascending order in the drawing.

Meanwhile, ink droplets are intermittently ejected from the nozzles onto the paper sheet S being transported so that the nozzle group forms a raster line on the paper sheet S. For example, the nozzle #1 forms a first raster line on the paper sheet S and the nozzle #2 forms a second raster line on the paper sheet S. Each of the raster lines is formed along the transporting direction. Hereinafter, the direction of the raster line is referred to as “the raster direction” (corresponding to “the relative movement direction”).

When an ink droplet is not adequately ejected due to clogging of a nozzle, a dot is not adequately formed on the paper sheet S. Hereinafter, a dot which is not adequately formed is referred to as “a defective dot”. Once a defective liquid ejection has occurred, the defective liquid ejection is not restored naturally during the printing so that a defective liquid ejection continuously occurs. As a result, defective dots are continuously formed on the paper sheet S in the raster direction, and the defective dots can be visually observed as a white or bright stripe on a printed image.

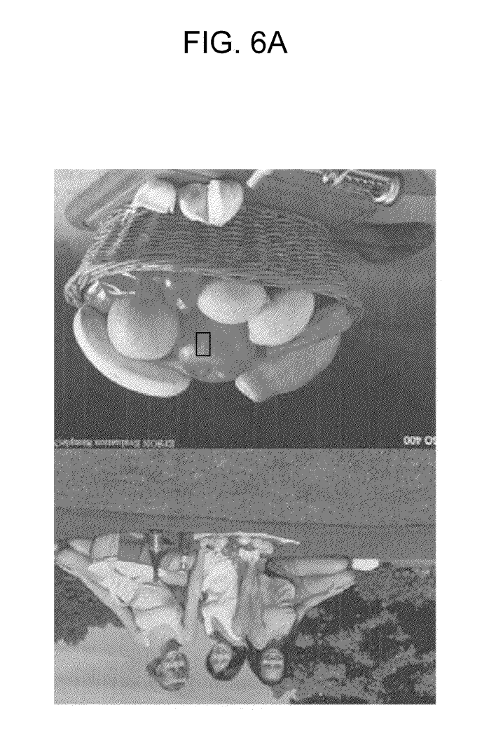

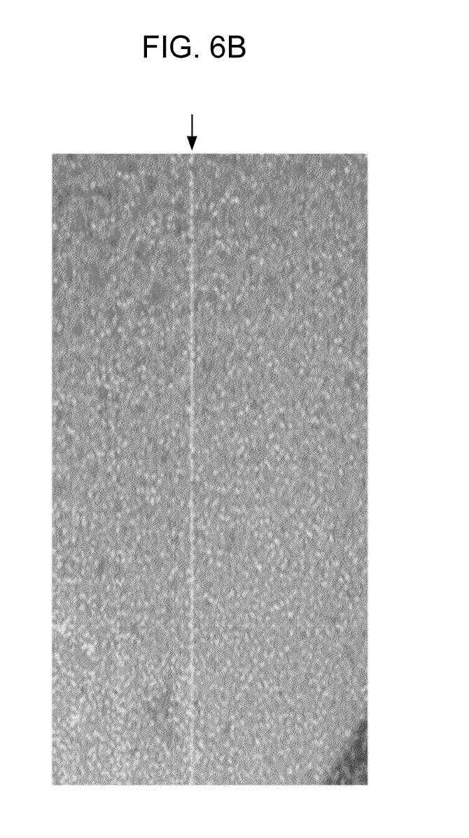

FIG. 6A is an explanatory view showing a printed image when a defective liquid ejection occurs. FIG. 6B is an enlarged view showing a portion having a defective dot enclosed by a square in FIG. 6A. As shown by an arrow in FIG. 6B, a vertical white stripe can be visually observed.

The controller 60 is a control unit (control section) that controls the printer 1. The controller 60 has an interface section 61, a CPU 62, a memory 63 and a unit control circuit 64. The interface section 61 performs transmission of data between the computer 110 as an external device and the printer 1. The CPU 62 is an arithmetic processing unit that controls the entirety of the printer 1. The memory 63 is adapted to retain an area for storing a program of the CPU 62 or a work area and has a memory device such as a RAM or an EEPROM. The CPU 62 controls each of the units via the unit control circuit 64 in accordance with the program stored in the memory 63.

[Structure of Detection Device 200]

As shown in FIG. 1, the detection device 200 is equipped with a scanner 210 as an example of a sensor and an ejection failure detection processing section 220 as an example of a detection section.

The scanner 210 is of a type of a linear sensor having a photosensitive section formed in one row and reads an image on the paper sheet S printed by the printer 1 while the paper sheet S is transported in the raster direction. Illumination light is projected to a reading portion of the scanner 210 so that the image printed on the paper sheet S can be read by means of the scanner 210. The scanner 210 has a width whereby an image having the same width as the paper sheet S can be simultaneously read. The scanner can read out colors printed by the printer 1 into respective colors.

A reading resolution of the scanner 210 in the paper width direction is higher than that of an image printed on the paper sheet S. To be specific, since the resolution of the printed image in the paper width direction is 720 dpi in the embodiment, it is preferable to make the reading resolution be two times or more of 720 dpi, that is 1440 dpi or more so that 1440 dpi is, for example, used in the embodiment.

On the other hand, reading is performed in such a manner that the reading resolution of the scanner 210 in the raster direction is made to be lower than the resolution of the image printed on the paper sheet S. For example, when it is assumed that a transporting speed of the paper sheet S is 254 mm/s and a time period (one scanning cycle) necessary for reading one reading line is 7 ms, the paper sheet S is transported by a distance of 1.78 mm during the reading. Namely, a line width of one reading line becomes 1.78 mm. Assuming that the printing resolution in the raster direction is 1440 dpi, one reading line corresponds to 100.8 dots on the basis of an expression of 1.78 mm×1440 dpi. That is, the reading resolution of read data in the raster direction corresponds to an image that has been compressed to approximately one hundredth of the printed image. Each reading line of the read data is constituted by a pixel value obtained by averaging pixels values of approximately 100 dots of the image printed in the raster direction for each color.

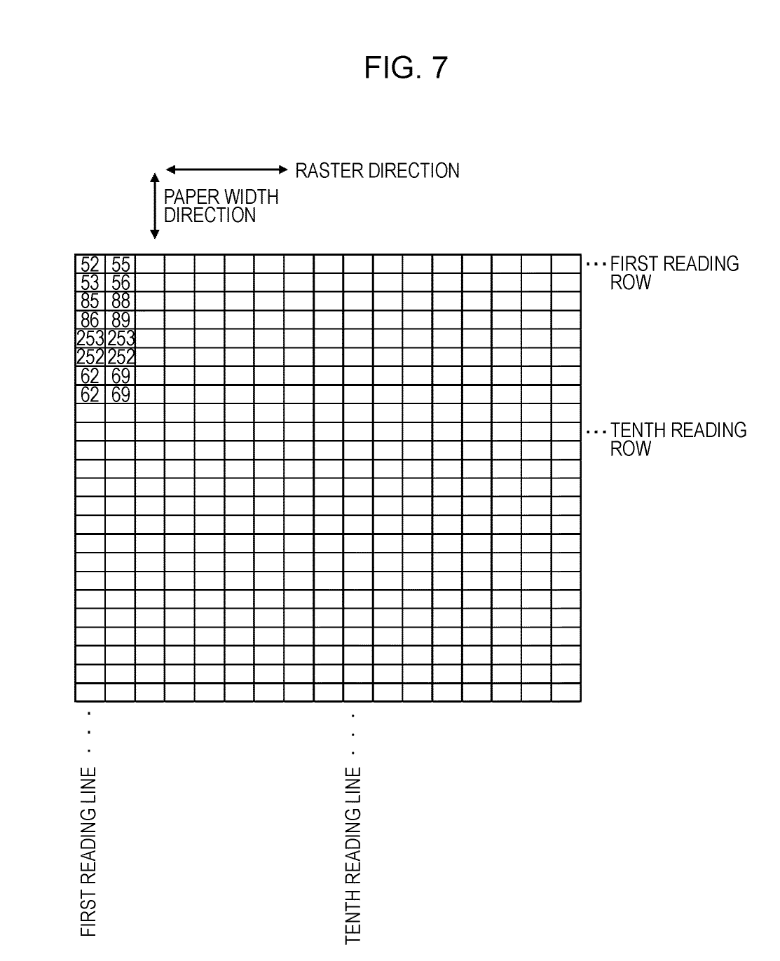

FIG. 7 is an explanatory view showing read data read by the scanner 210 when its scan rate is set to 7 ms. As shown in FIG. 7, regarding cells in a quadrille pattern obtained by dividing a plane in the raster direction and the paper width direction, the read data has a position of the cell and a pixel value read at the position correlated with each other. For ease of explanation, it is assumed that as shown in the drawing, rows in the raster direction are sequentially defined to be from the first reading row to the 1440-th reading row and lines in the paper width direction are numbered from the first reading line to the N-th reading line in a reading sequence of the scanner 210.

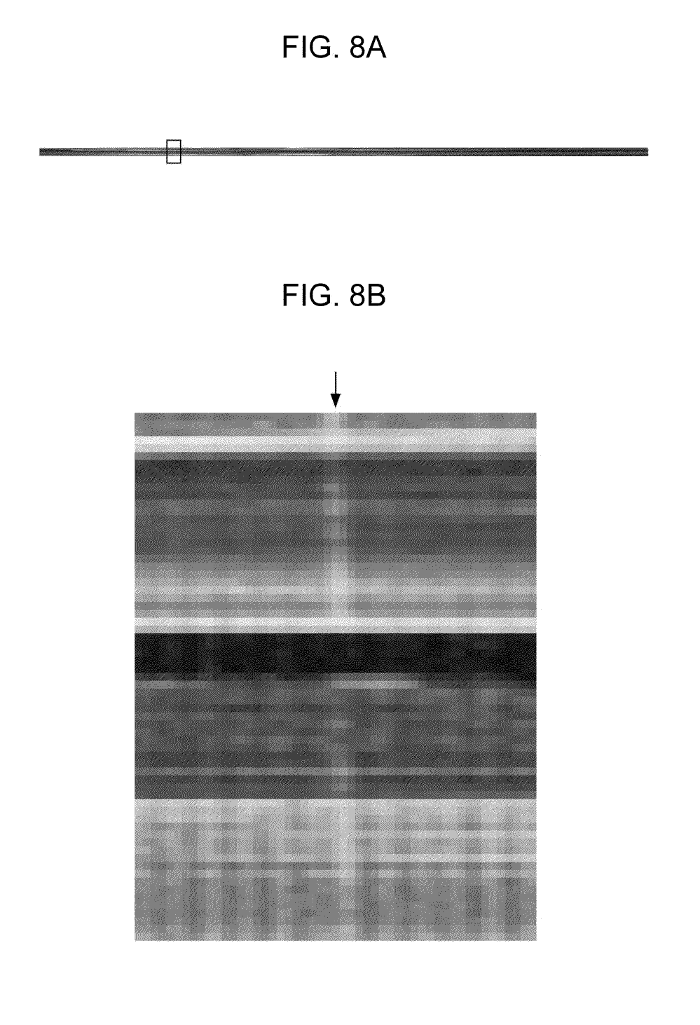

FIG. 8A is a schematic view showing an image obtained by reading the printed image in FIG. 6A by using the scanner 210. As shown in FIG. 8A, the image read by the scanner 210 is made to be an image that has been compressed in the raster direction approximately one hundredth of the original image. On the other hand, FIG. 8B is an enlarged view showing a portion having a defective dot enclosed by a square in FIG. 8A. As shown by an arrow in FIG. 8B, a vertical white stripe can be visually observed.

As shown in FIG. 1, the ejection failure detection processing section 220 has an interface 261, a CPU 262 and a memory 263. The interface 261 performs transmission of data between the computer 110 as the external device and the detection device 200. The CPU 262 is an arithmetic processing unit that controls the entirety of the detection device 200. The memory 263 is adapted to retain an area for storing a program of the CPU 262 or a work area and has a memory device such as a RAM or an EEPROM. The CPU 262 performs processing of data in accordance with the program stored in the memory 263.

The ejection failure detection processing section 220 acquires data (read data) of an image read by the scanner 210 and image data from the printer 1 or the computer 110. The ejection failure detection processing section 220 produces reference data having a resolution the same as the reading resolution of the read data on the basis of the resolution of the image data. The ejection failure detection processing section 220 compares the read data with the reference data so as to detect a defective liquid ejection of a nozzle.

[Processing for Detecting Ejection Failure of Nozzle]

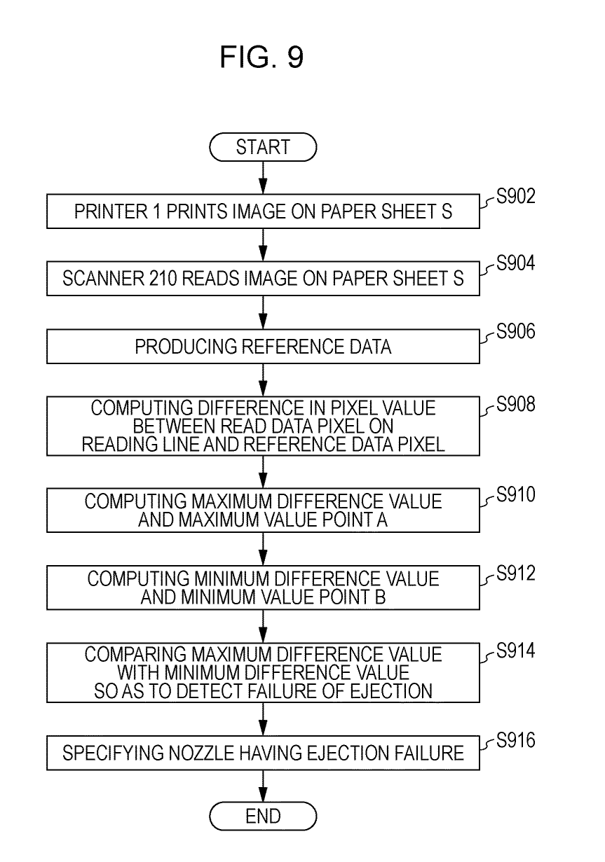

FIG. 9 is a flowchart of processing of detecting a defective liquid ejection. First, the printer 1 performs printing on the paper sheet S in accordance with image data received from the computer 110 (S902).

The scanner 210 reads the image printed on the paper sheet S in such a manner that the reading resolution is made to be lower than the resolution of the image data in the raster direction (S904). To be specific, the scan rate is set to 7 ms and the scanner 210 reads the image from the first reading line to the N-th reading line so as to make one reading line to correspond to 100.8 dots.

The ejection failure detection processing section 220 acquires image data from the controller 60 or the computer 110 and digitally processes the image data so as to produce the reference data having a resolution the same as the reading resolution of the read data (S906). To be specific, since one reading line corresponds to 100.8 dots in the raster direction, a dot corresponding to the first reading line can be produced in such a manner that a value obtained by multiplying a pixel value of the 101-th dot by 8/10 is added to a sum of pixel values of the first dot to the hundredth dot to obtain a value and the value is divided by 100.8. Note that the reference data is produced for each color. In addition, since the reading resolution in the paper width direction is 1440 dpi, the image data having a resolution of 720 dpi is corrected with respect to each color so as to convert it into the image data having a resolution of 1440 dpi, thereby producing reference data.

The ejection failure detection processing section 220 computes a difference between a pixel value of a pixel of one row of read data on the reading line and a pixel value of a pixel of the reference data corresponding to the pixel of the one row from one end to the other end of the row (S908). The ejection failure detection processing section 220 computes a maximum value point A where the difference shows its maximum value and the maximum difference value (S910).

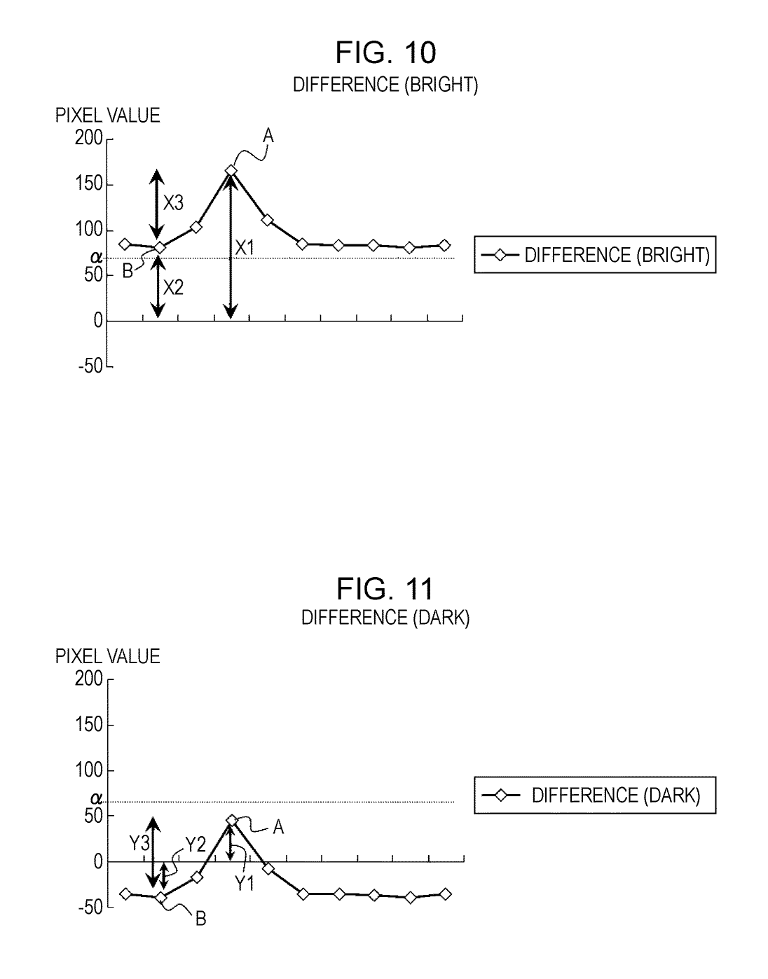

FIGS. 10 and 11 are graphs showing a part of a line chart formed by connecting plotted points of differences between the pixel values of the read data pixels of one row on the reading line and the pixel values of reference data pixels corresponding to the pixels of the one row. As shown in FIGS. 10 and 11, the difference between the pixel values shows its maximum value at the maximum value point A. Here, the maximum means that the difference value at a point in the series points is greater than the pixel values of both adjacent pixels. While a point where the difference value shows its maximum value is only the maximum value point A in the graphs in FIGS. 10 and 11, the difference can show its maximum at a plurality of points. The ejection failure detection processing section 220 computes the maximum difference value and the maximum value point pixel that takes the maximum difference value.

In addition, the ejection failure detection processing section 220 computes a minimum value point B and a minimum difference value at a point where the difference shows the minimum value B (S912). Further, the ejection failure detection processing section 220 compares the maximum difference value at the maximum value point A with a minimum difference value at a minimum value point B which is the nearest to the maximum value point A in the minimum value points B so as to detect a defective dot (S914). Namely, the ejection failure detection processing section 220 computes a difference between the maximum difference value and the minimum difference value. It determines that there is not a defective dot when the difference between the difference values is not greater than a predetermined value α and determines that there is a defective dot when the difference between the difference values is greater than the predetermined value α.

It is determined that a defective liquid ejection has occurred in a nozzle corresponding to a reading row having a defective dot (S916). Here, the m-th nozzle corresponding to the n-th reading row having a defective dot can be specified by the following formula.

m=n×(a resolution of a printed image/a reading resolution) (Formula I)

Here, the scanner 210 reads an image printed on the paper sheet S with a resolution higher than that of the image in the paper width direction. Therefore, when a reading row having a defective dot is specified in the read data, it is possible to determine which nozzle has a defective liquid ejection.

Thus, with the above first embodiment, it is possible to prevent false detection in the detection of a defective liquid ejection. For example, in the case where dots are formed in accordance with image data without a defective liquid ejection in a nozzle in the printer 1, when the scanner 210 can read the printed image such that the brightness in the reading is made to be the same as that of the image data, a difference in a pixel value between the reference data and the read data theoretically becomes zero. Here, when a nozzle has a defective liquid ejection, a dot is not formed in an image so that a pixel value becomes large. Therefore, by computing the difference in a pixel value between the reference data and the read data, presence or absence of a defective liquid ejection in the nozzle can be determined. Namely, it is judged that a defective liquid ejection does not occur when the difference is zero and it does occur when the difference is a positive value.

However, when there is a reading error in which the brightness of reading by the scanner 210 is higher than that of the image data irrespective of presence or absence of a defective liquid ejection in a nozzle, differences between the read data and the reference data become large values overall as shown in FIG. 10. Namely, when paying attention to only the difference value between the read data and the reference data, the difference value becomes X2 which is greater than a even at the minimum value point B not having a defective liquid ejection so that it is erroneously determined that there is a defective liquid ejection, resulting in false detection.

In addition, when there is a reading error in which the brightness for reading by the scanner 210 is lower than that of the image data irrespective of presence or absence of a defective liquid ejection in a nozzle, differences between the read data and the reference data become small values overall, as shown in FIG. 11. Namely, when paying attention to only the difference value between the read data and the reference data, the difference value becomes Y1 which is smaller than a even at the maximum value point A having a defective liquid ejection so that it is erroneously determined that there is not a defective liquid ejection.

In the first embodiment, the maximum difference value and the minimum difference value are compared with each other. As shown by X3 in FIG. 10 and Y3 in FIG. 11, a reading error of the scanner 210 can be cancelled by comparing the maximum difference value A and the minimum difference value B with each other so that it is possible to prevent false detection.

In addition, when reading is performed by the scanner 210 while maintaining accuracy in the detection of a defective liquid ejection, the reading resolution in the raster direction is reduced so that an amount of data to be processed in the detection of a defective liquid ejection can be reduced.

As shown in FIG. 6B, when a defective liquid ejection occurs in a nozzle, a white or bright stripe can be visually observed at a raster line formed by a defective dot. In addition, as shown in FIG. 8B, even when the scanner 210 reads collectively 100 dots of an image in the raster direction, only the image is compressed in the raster direction and a white or bright stripe is still visually observed. By paying attention to the above fact, when an amount of data is compressed in the raster direction, it is possible to reduce an amount of data to be processed in the detection of a defective liquid ejection. On the other hand, by increasing the reading resolution in the paper width direction to be more than the resolution of printing, a nozzle having a defective liquid ejection can be specified.

The invention is useful for, for example, performing a large amount of printing work for business. Continuing of printing with a defective nozzle results in production of a large amount of defective printed materials. In accordance with the invention, since a defective liquid ejection of a nozzle can be detected during printing, the printing can be immediately stopped upon occurrence of a defective liquid ejection. In addition, when a defective liquid ejection such as clogging of a nozzle is recovered by performing cleaning or flushing of the head, the printing can be immediately restarted.

In order to further reduce an amount of data to be processed, detection of a defective liquid ejection is not performed for all of the printed materials, but can be performed at a frequency of once for every several printed materials. The more the detection frequency is reduced, the more the amount of data to be processed is reduced.

### Second Embodiment

While the line printer is used in the first embodiment, a serial type printer is used in a second embodiment. As in the first embodiment, the printing system 100 of the second embodiment includes the printer, the computer 110, the display device 120, the input device 130, the recording/playing device 140, and the detection device 200.

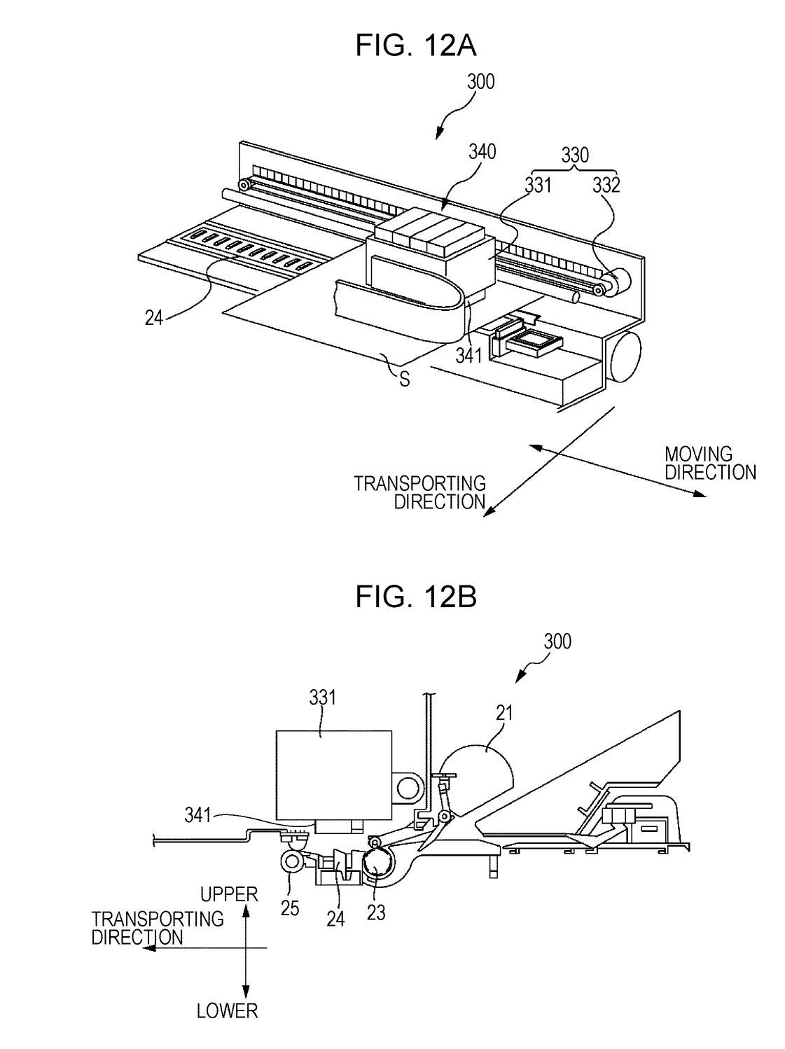

FIG. 12A is a schematic view showing an entire structure of the serial type printer 300. FIG. 12B is a cross sectional view showing the entire structure of the printer 300. Differences between the printer 300 and the printer 1 are mainly described below.

The printer 300 is equipped with a carriage unit 330. The carriage unit 330 is adapted to move a head unit 340 in a paper width direction. The carriage unit 330 has a carriage 331 and a carriage motor 332. The carriage 331 can be driven by the carriage motor 332 so as to be reciprocated in the paper width direction. In addition, an ink cartridge containing ink as an example of a liquid is detachably attached to the carriage 331.

The head unit 340 is adapted to eject ink onto the paper sheet S. The head unit 340 is equipped with a head 341 having a plurality of nozzles. Since the head 341 is mounted on the carriage 331, the head 341 moves in the paper width direction in association with the movement of the carriage 331 in the paper width direction. The head 341 intermittently ejects ink during the movement in the paper width direction, a dot row (a raster line) along the paper width direction is printed on the paper sheet S.

In the meantime, while the printer 300 performs printing on the paper sheet S, it alternately repeats a dot forming operation for forming dots on the paper sheet S by ejecting ink from a nozzle on the head 341 moving in the paper width direction and a transporting operation for transporting the paper sheet S in a transporting direction by means of the transportation unit 20. In the dot forming operation, ink is intermittently ejected from the nozzle so that a dot row constituted by a plurality of dots along the paper width direction is formed. The dot row is referred to as the raster line. The raster direction (corresponding to a relative movement direction) of the raster line is same as the paper width direction.

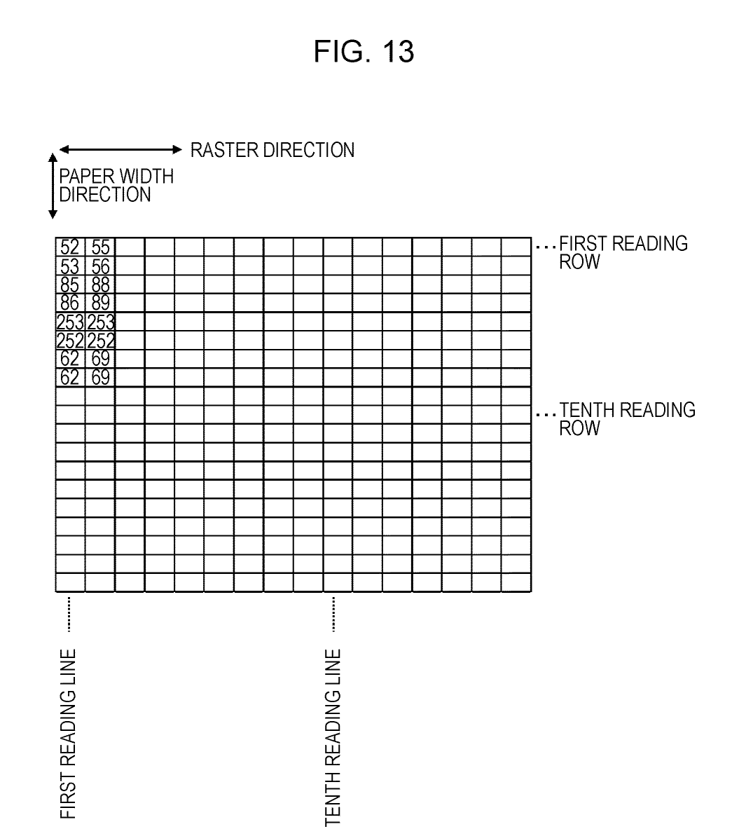

FIG. 13 is an explanatory view showing read data read by the scanner 210 when its scan rate is 7 ms. As shown in FIG. 13, regarding a cell in a quadrille pattern obtained by comparting a plane in the raster direction and the paper transportation direction, the read data has a position of the cell and a pixel value read at the position correlated with each other. Namely, while the plane is comparted in the raster direction and the paper width direction in the quadrille pattern in the first embodiment, the plane is comparted in the raster direction and the paper transportation direction in the quadrille pattern in the second embodiment, which is different from the first embodiment. Other configurations are the same as the first embodiment.

A flow of an ejection failure detection process in the second embodiment is the same as the flow of the process shown in FIG. 9.

In accordance with the second embodiment, by comparing the maximum difference value and the minimum difference value with each other, it is possible to prevent false detection in the detection of a defective liquid ejection. In addition, also with the second embodiment, when reading is performed by the scanner 210 while maintaining accuracy in the detection of a defective liquid ejection, the reading resolution in the raster direction is reduced so that an amount of processing data in the detection of a defective liquid ejection can be reduced.

### Third Embodiment

In the first and second embodiments, the reference data is produced by digitally processing the image data (S906 in FIG. 9). On the other hand, in a third embodiment, in a case where an identical image is printed on a plurality of media, a printed material obtained by printing just after the cleaning or flushing of the head unit 40 is performed, is read by the scanner 210 so as to produce a reference data. Namely, since a nozzle is not clogged just after the cleaning or flushing, a printed material with good quality without having a defective dot can be obtained. As long as data obtained by reading the printed material with good quality is used, the data can function as the reference data.

In accordance with the third embodiment, by comparing the maximum difference value and the minimum difference value with each other, it is possible to prevent false detection in the detection of a defective liquid ejection. In addition, also with the third embodiment, when reading is performed by the scanner 210 while maintaining accuracy in the detection of a defective liquid ejection, the reading resolution in the raster direction is reduced so that an amount of processing data in the detection of a defective liquid ejection can be reduced.

### Another Embodiment

While the printers 1 and 300 as examples of a fluid ejection device that form an image by ejecting ink, are described in the above embodiments, the fluid ejection device is not limited thereto. The invention can be practically applied to detection of a defective liquid ejection of a fluid ejection device that ejects a fluid other than ink (including a liquid, a liquid containing particles of a functional material dispersed therein, a liquid like a gel and a particle as an aggregation of fine particles).

The ejection failure detection device can be applied to a fluid ejection device for ejecting a fluid containing a material such as an electrode material or a colorant dispersed or dissolved therein, the material being to be used for manufacturing, for example, a liquid crystal display, an EL (electro luminescence) display and a surface light-emitting device, fluid ejection device for ejecting a living organic material to be used for manufacturing a biochip, or a fluid ejection device for ejecting a fluid to be a specimen to be used as a precision pipette. Further, the ejection failure detection device can be applied to a fluid ejection device for ejecting a lubricant to a precision instrument such as a watch or a camera in a pinpoint manner, a fluid ejection device for ejecting, on a substrate, a liquid of a transparent resin such as an ultraviolet curable resin for forming a micro hemispherical lens (an optical lens) to be used for an optical communication element, a fluid ejection device for ejecting an acid or alkaline etching liquid to be used for etching a substrate, and a fluid ejection device for ejecting a gel. The method for detecting a defective liquid ejection according to the invention can be adopted to any one of the above fluid ejection devices.

The above embodiments are shown to facilitate understanding of the invention, but not to limit the scope and spirit of the invention. The invention can be changed or modified without departing from the scope of the invention and it is needless to say that its equivalent is included in the scope of the invention. Particularly, an embodiment described below is also included in the scope of the invention.

[Regarding Head]

In the above embodiments, the head 41 that ejects ink by using a piezoelectric element, is used. However, a technique for ejecting a fluid is not limited to the above. A technique for ejecting a fluid by generating a bubble by heat can be, for example, used or another technique can be used.

The disclosure of Japanese Patent Application No. 2009-077326 filed Mar. 26, 2009 including specification, drawings and claims is incorporated herein by reference in its entirety.

What is claimed is:

1. A method for detecting a defective liquid ejection comprising:
reading, by means of a sensor, an image which is formed on a medium by nozzles ejecting a fluid onto the medium in accordance with image data while being moved relative to the medium in a relative movement direction;
obtaining differences between pixel values of read data pixels continuously arranged in a row in a direction intersecting with the relative movement direction in data read by the sensor and pixel values of image data pixels corresponding to the read data pixels; and
detecting a defective liquid ejection of a nozzle by comparing a maximum difference value at a time when the differences show a maximum value with a non-maximum difference value at a time when the differences do not show the maximum value.

2. The method for detecting a defective liquid ejection according to claim 1, wherein
the non-maximum difference value is a minimum difference value at a point where the differences show a minimum value and are the closest to a point where the differences show a maximum value in points where the differences show the minimum value.

3. The method for detecting a defective liquid ejection according to claim 1, further comprising:
forming reference data having a resolution the same as a reading resolution in the relative movement direction in accordance with the image data, wherein
when an image formed on the medium is read by means of the sensor, the reading is performed in such a manner that a reading resolution of the sensor is made to be lower than the resolution of the image data in the relative movement direction, and
when the differences are obtained, differences between pixel values of the read data pixels and pixel values of reference data pixels respectively corresponding to the read data pixels in the reference data are obtained from one end to the other end of the row.

4. The method for detecting a defective liquid ejection according to claim 1, wherein
the reading is performed by means of the sensor in such a manner that a reading resolution of the sensor is made to be higher than a resolution of the image data in a direction intersecting with the relative movement direction.

5. The method for detecting a defective liquid ejection according to claim 3, wherein
the reference data is produced by processing the image data.

6. An ejection failure detection device comprising:
a sensor that reads an image which is formed on a medium by nozzles being moved relative to the medium in a relative movement direction while ejecting a fluid in accordance with image data;
a difference computing section that computes a differences between pixel values of read data pixels continuously arranged in a row in a direction intersecting with the relative movement direction in data read by the sensor and pixel values of image data pixels corresponding to the read data pixels; and
a detecting section that compares a maximum difference value at a time when the differences show a maximum value with a non-maximum difference value at a time when the differences do not show a maximum value so as to detect a defective liquid ejection of a nozzle.
